(19) United States
(12) Patent Application Publication
(10) Pub. No.: US 2016/0030856 A1
(43) Pub. Date: Feb. 4, 2016

(54) DISTILLATION REACTOR MODULE

(71) Applicant: TRANSTAR GROUP, LTD, Hong Kong (CN)

(72) Inventors: Allen KAPLAN, Miami Beach, FL (US); Randall BRADLEY, Ft. Lauderdale, FL (US)

(21) Appl. No.: 14/776,734

(22) PCT Filed: Mar. 18, 2014
(86) PCT No.: PCT/US2014/031118

§ 371 Date: Sep. 14, 2015

Related U.S. Application Data
(60) Provisional application No. 61/801,491, filed on Mar. 15, 2013.
(60) Provisional application No. 61/800,209, filed on Mar. 15, 2013.

(51) Int. Cl. B01D 3/00; C10G 7/06; B01D 39/20; B01D 3/10; B01D 3/06

(52) U.S. Cl. CPC B01D 3/009; B01D 3/10; B01D 3/006; B01D 3/06; B01D 39/2027; C10G 7/06

(57) ABSTRACT

The distillation reactor consists of a reactor apparatus with corresponding method of upstream distilling and purification of carbon based liquid or liquidized streams for use as fuels, lubricating oils and or gaseous energy and electricity production. The distillation reactor consolidates the atmospheric and vacuum distillation processes along with desalting, defueling, deasphalting, fractionation, thin/wiped film evaporation and Hydro finishing into an advanced high velocity, high volume single reactor system. Carbon based feed streams include either a single stream or preferably, a combined stream of liquefied coal slurries, crude oils, spent oils, Pyrolyic oils and or peat or other plant carbon derived liquids, vapors, mists or gases. The method further consists of controlling the mix ratio, flow velocity, sequential fractionation and filtration technology and processing atmospheres of the carbon feeds with the reactor apparatus. The combined apparatus and method allows for a refinery to consistently produce a finished barrel of oil well below traditional costs and at a higher efficiency than current art and prior art.

### FIELD OF THE INVENTION

The present invention relates to a combined apparatus and method for purifying mixed carbon based feeds within a refinery module. In particular, the combined apparatus and method relates to the ability to cyclonically purify mixed carbon based feeds while separating, capturing, containing and harvesting contaminants at the initial upstream processing location. The upstream processing allows for the apparatus to produce refined oils and fuels at a fraction of the cost by speeding up the processing cycle, product purity and illuminating numerous other processes and equipment found in current art. The combined apparatus includes: a desalt, pretreatment system integrated with the distillation reactor having a vacuum distillation chamber; an atmospheric distillation chamber; a central chamber flash zone with an upper filtration system; and a vortex processing zone.

### SUMMARY OF THE INVENTION

The combined apparatus, including the distillation reactor module can be utilized with various types of operations and is adaptable for use in an integrated eco-friendly system, methods and processes (hereinafter the “EFSMP” or the integrated matrix system”).

One or more objectives of the present invention is to consolidate current art refinery processing steps, accelerate processing cycle speeds and significantly raise daily production volumes through a simplified, standardized design all without moving parts or complex internal packing systems, yet being able to effectively operate under continuous or pulsed high-velocity flows.

A continuous pre-treatment process and method includes chemically formulating and mechanically combining a mix of varied carbon based liquid streams, high velocity colloidal blending, thermal flash vaporizing, compressing and subsonic separation and processing of the heavy from the light base oils for final refining into lubricating oils, products and or fuels. The system and apparatus may also be modified as a waste water distillation reactor to pre-treat, pre-process and distill the contaminated water back into a purified state.

The raw feed streams may include individually or as a mix light crude, heavy crude, shale oil, tar sands oil, waste oil, Pyrolyic oil, peat, bitumen, residuum and other carbons based liquids with thermal energy storage value.

The invention apparatus can include a central reactor flash zone where the pretreated feed stream is vaporized for separation of light from heavy oils directing the lights upwards through a filtration system into the atmospheric distillation chamber and the heavy downwards into the vacuum distillation chamber for processing.

The heavy oil vapors upon entering the vacuum distillation chamber are immersed within a processing gas atmosphere such as propane, butane, or ethane and/or various other gases injected individually or as a mixture to assist throughout the cyclonic fracturing, desalting, deasphalting and purification processes.

Alternatively, inert gases, such as helium or argon, may be utilized in conjunction with a thorough pretreatment process thus allowing for a single transport gas stream to be utilized throughout both the vacuum and atmospheric distillation processes.

The downward vaporized flow then enters into a multiple stage heavy oil vacuum distillation system inclusive of a primary central chamber located cyclone equipped with a heat inner cone surface which serves as a centrifugal forced wiped film evaporator, a secondary downstream cyclone or parallel series of cyclones and optionally additional downstream parallel cyclones or series of cyclones. All cyclones are aimed downwards with the narrow opening at the bottom. The vacuum distillation system operates at a high subsonic cyclonic flow rate to optimize the centrifugal fracturing force, the vortex flow compression and separation effect on heavy, tar sand, shale oil and contaminated oil streams.

Each of the various cyclonic stages work in conjunction with the processing atmospheres, temperature ranges and treatments all of which further refine out contaminants from the base oil until a 100% stream filtration is achieved. The vacuum distilled oils include light vacuum gas oil, heavy vacuum gas oil and residuum.

Water vapor is gravity desalted and condensed by a series of alternately layered electrode grid baffle plates located in the bottom section of the vacuum chamber. As the mixed vapors desalt they separate and condense into water and residuum droplets both of which drop into a bottom reactor collection pool where the lighter water floats on top of the heavier residuum sinks to allow for a simple, complete separation and independent extraction of each level for recycle. Any sediment will drop to the very bottom of the collection pool for extraction and special processing.

The water is extracted and forwarded to a filtration apparatus with an internal process system of 1) a glass fiber filter within a foam metal superstructure to withstand the high flow velocity, 2) a secondary activated wood based carbon filter bed, 3) an ion exchange resin column to remove nitrogen compounds followed by 4) an activated wood based carbon filter bed and a 5) an activated carbon aerogel filter with cast rare earth metallized magnetic superstructure. The final water purification level is below 0.1 ppm with metal concentration below detectible limits making it safe as a drinking water.

The oil vapors now free of sediment are now able to rise where the heavy vacuum oil and light vacuum gas oil can be side port extracted at a predetermined peak float level with the ultra-light oil vapors continue rising up into and through the primary and secondary vortex cones as an inner upward spiraling vortex flow. Upon the final processed light vapors reaching the Chalcogel filtration layer (#18) they mix with flash zone's light oil vapors and are final filtered before entering into the atmospheric distillation processing. The rising vapors are pulled through the Chalcogel filtration zone by the upper chamber's upward spiraling flows vacuum effect.

The filtered light vapors then enter the first of four or more ascending atmospheric processing chambers for fractionation, distillation and individual extraction of gas oil, diesel oil, jet fuel, kerosene, heavy naphtha, light naphtha and LPG gas. The vapors are relay propelled through the chambers by a series of high velocity air-foil processing fans. The fans are pressurized by intensifier pumps or other high velocity pumps and contain hydrogen and or other processing gases. The pressurized hydrogen atmosphere, in essence, hydrotreats as it fractionates, hydro-desulfurizes, and allows for a final hydro-finishing function for the light base oils. The hydrogen is also able to effectively control the base oil's final coloring while removing any odors typically found in spent oil or Pyrolyic feed stock.

The upward flowing vapors are propelled around the inner processing chamber's radius to a high-velocity flow upon entering the first atmospheric processing chamber by a series of relayed bladeless air-foil, high velocity processing fans. The fans are hydrogen pressurized by intensifier or other high velocity pump systems and flow speed regulated to meet daily production demand. The bladeless fans are systematically located just above each processing chamber's ceiling baffle plates, Nautilus ear shroud and corresponding oil extraction ports.

The chamber ceiling baffles serve as a processing flow compression mechanism as the pulsed high-velocity upward flow strikes and mushrooms inwards, then downward spirals through the center section of the reactor chamber thereby creates enough of a cross section flow to allow for the complete isolation and extraction of each specific oil vapor cut by its density and weight.

The process may be operated as a continuous or pulse timed flow rate thus allowing the refinery to customize the processing saturation requirements exactly to the feedstock consistency for a multitude of carbon based feedstock. The simultaneous opposing dual vortex flows within each of the atmospheric processing chambers is repeated until the vapors have been purified and extracted by weight and density with the light naphtha being extracted at the very top of the reactor dome.

The distillation reactor system can be operated independently from or incorporated into an integrated module or eco-friendly matrix system.

### BRIEF DESCRIPTION OF THE FIGURES

FIG. 1 shows the Distillation Reactor Apparatus.

FIG. 2 shows another configuration of the Distillation Reactor Apparatus.

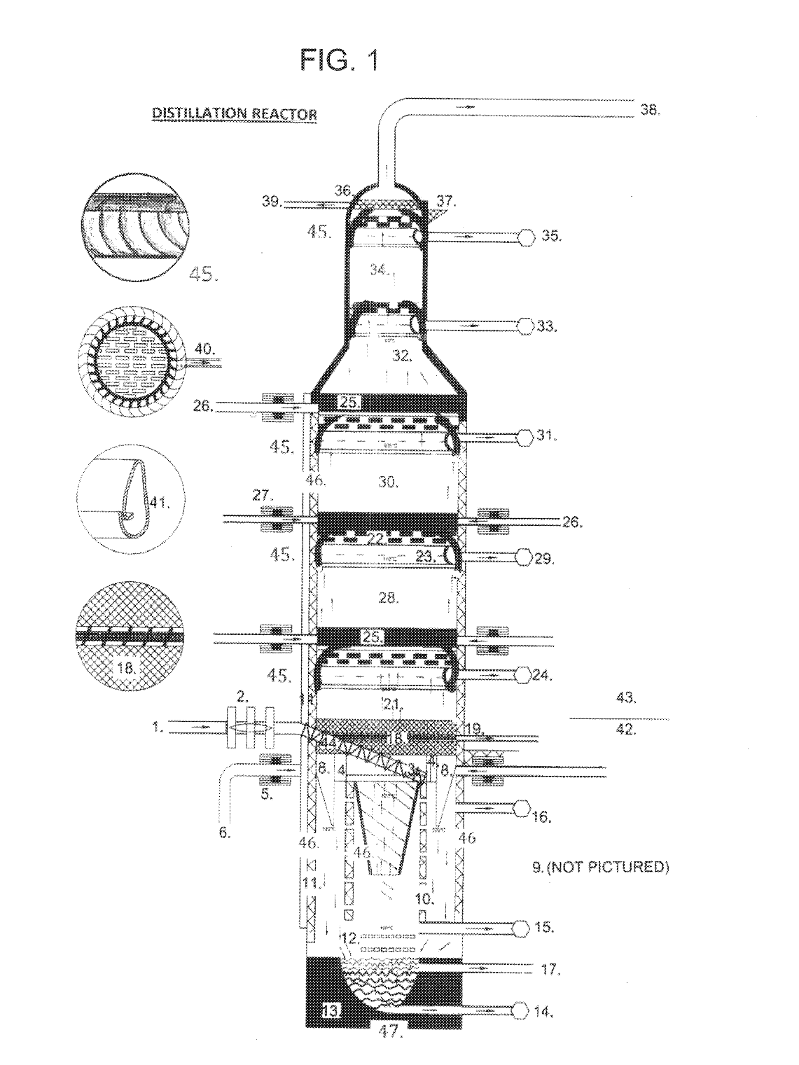

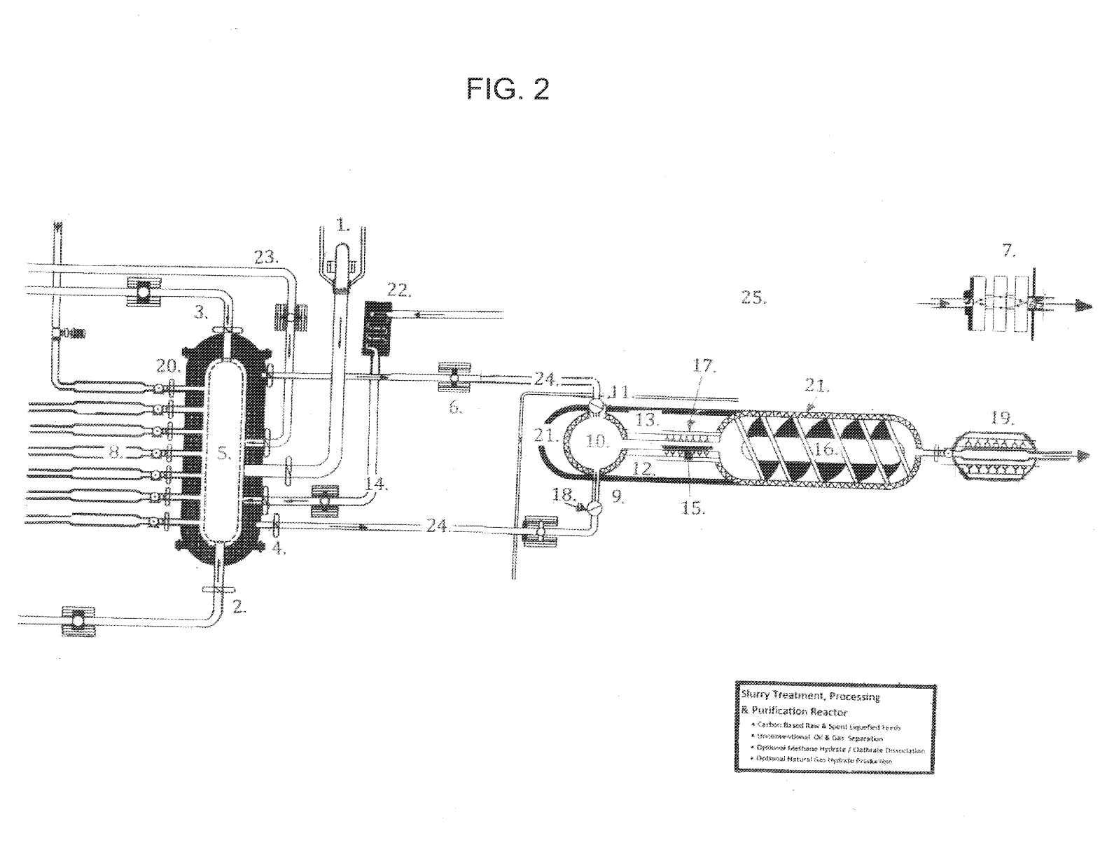

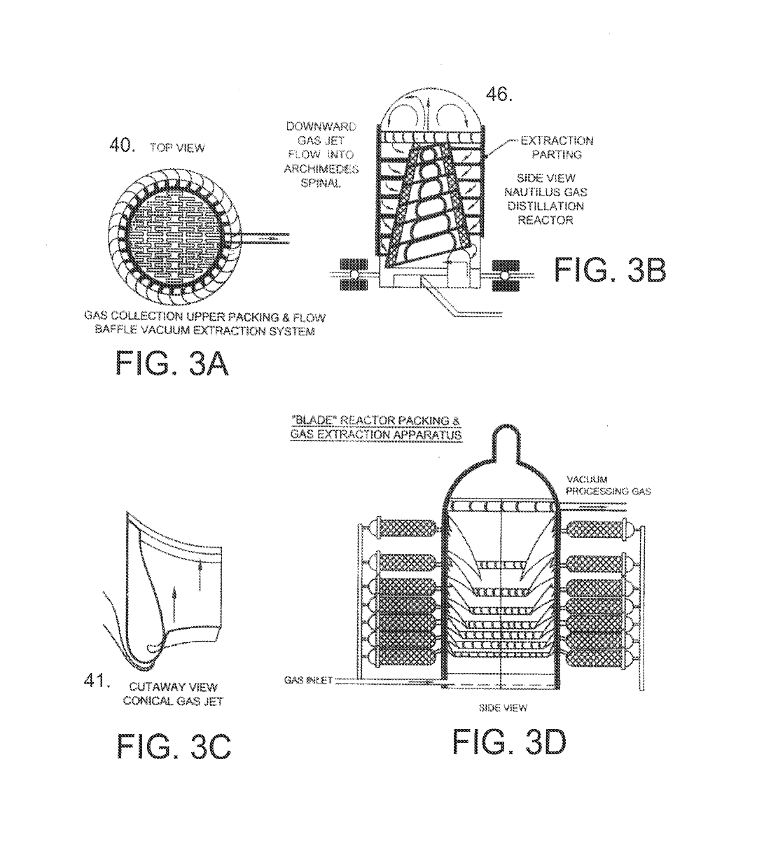

### DETAILED DESCRIPTION OF THE INVENTION

The present invention is further described in the detailed description which follows, in reference to the drawings by way of non-limiting examples of embodiments of the present invention, in which like reference numerals represent similar parts throughout the several views of the drawings. The particulars shown herein are provided by way of example and for purposes of illustrative discussion of the embodiments of the present invention only, and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making it apparent to those skilled in the relevant art how the several forms of the present invention may be embodied and used in practice.

Pre-Treatment may vary depending upon the carbon feed stream or streams being utilized and include a single or mixed feed consisting of any type of light or heavy crude, waste, Pyrolyic, coal slurry, peat, shale, tar sands, bitumen or other carbon based oils. The reactor apparatus is designed to process any single or combined carbon stream whether it is externally or internally pre-treated and pre-heated for distillation.

Pre-treatment is achieved by the merging of various high pressure pipelines with each conveying an individual feed line of crude oil, (1) Pyrolyic oil and (3) spent oil with computer controlled metering for accurately (2) proportioning each feed stream into the continuous series of heated batch mixing tanks (5). The proprietary mixing formula can consist of various formulas to better adapt to any composition variances within each feed stream, but concerning recycle oil preferably consists of 45% Pyrolyic oil, 45% spent oil and 10% crude oil mix. The number of multiple batch mixing tanks enables the system to have a continuous, uninterrupted processing feedstream flow.

Each mixing tank is preheated to a temperature range of 120° to 350° Celsius and for the best results between 145° and 285° Celsius. Alternatively, or in conjunction, the pre-heating may accomplished with pipe furnace feed lines into the mixing tanks and or entry into the distillation reactor. The combined heat, mixing action and additives begin the pre-fractionation process by loosening the bonds of contaminates and impurities from the base oil. Ultra-high frequency ultrasound has been added to the apparatus to optimize the effectiveness of the pre-treatment separation process.

Catalysts, hydroxides, surfactants, solutions, additives, chelating agents and reagents may be added individually or collectively to assist in the pre-fractionation process (8). Base oil additives such as alkali or alkaline hydroxides, which include sodium, potassium, calcium, magnesium, lithium and alumina, are used to neutralize acids and assist in flux separating impurities. Preferred are strong base oil additives such as sodium or potassium hydroxides formulated in aqueous solution in a ratio of 1% to 3% of pure basic mass for injection into each mixing tank.

Additional types of additives may include those which serve as downstream rust and corrosion inhibitors and solvents that remove undesirable aromatics from the crude oil such as methylpyrrolidone which works in unison with the hydrogen atmosphere of the vacuum distillation chamber.

Processing materials may be directly injected into the invention distillation reactor's gas injection port system and or the Chalcogel filtration system as a vapor, mist or in a supercritical state. All pre-treatment materials may be contained for recycle through the Chalcogel filtration system located within the invention reactor apparatus. The Chalcogel filters are removable through a side reactor exit door allow for them to be cleaned and reused.

Demulsifiers, nickel-molybdenum catalysts, diammonium phosphate aqueous solution, Toluene-alcohol and dodecane-alcohol (ethanol and 1-butanol), methyl ethyl ketone and reagents are optional. Bitumen based oils are diluted with naphthenic or paraffinic solvents to lower its viscosity and facilitate the separation process.

Target waste oil contaminants include trace metals, sulfur, nitrogen compounds, oxygen, water, fuel and oil additives, diesel fuel, chlorine, volatile and semi volatile polar and non-polar organics, soot particles, benzene, styrene, naphthalene, trichlorofluoromethane,1,2,4 and 1,3,5-trimethyl benzene, acenapthylene, isophorone, 1-methyl-napthalene and 2-methyl-napthalene, phenantrene and exhaust condensate amongst others.

Once the individual mixing tanks have completed the computer timed treatment process the contents are vacuum released into a dual exiting pipe duct system to which each contain a section of rare earth high-powered magnets to assist in the extraction of both ferrous and non-ferrous trace metals from the stream prior to entering the colloidal chamber.

The opposing duct flows are then accelerated by intensifier pumps (6) to a high subsonic velocity which is computer controlled through a regulator located just downstream from each pump. The close proximity ensures that the two continuous flow streams are identical in volumetric flow rate and fluid viscosity so the two streams meet exactly in the central colloidal chamber (31) at optimum high-velocity and optimum colloidal impact force without interruption or flow deviation (38).

The high shear force (33) of the colloidal impact is able to loosen, fracture and or break the molecular bonds while thoroughly saturating the feed contents into a finely textured flow of slurry. The slurry is then forwarded as a continual flow through the transfer piping system (36) into the low pressure conveyance chamber (39) where it is flash vaporized before entering the impinging jet (7) or alternatively the turbine exhaust stream (not pictured) and conveyance piping system. The turbine exhaust flow power source combines kinetic energy with thermal pre-heat while the turbine(s) are simultaneously generating electric power. The turbine engine exhaust power is an integral part of this invention as all exhaust contaminants will be removed during the processing.

Shear rates of 107s-1 with channel velocities of 400 m/s achievable in the colloidal process. Optionally, the low pressure transfer piping system can include an electro-cavitation apparatus with central chamber targeted metamaterial absorbing core plate or tube or rod (40). The centrally mounted core plate, tube or rod spans the length of the transfer pipe (39), which is predetermined by projected flow velocities and required processing time based on the flow duration and viscosity. The cavitation energy enables the molecular bonds to forcefully separate, thus adding to the demulsification of the hydrocarbons from water, natural surfactants and the contaminating substrates. The preferred cavitation pressure range is about 100 psi to 1,000 psi. This process and apparatus enables a highly efficient ancillary separation method which can work in conjunction with chemical emulsifiers or in place of them. It also has the ability to balance and control the high ultrasonic energy cavitation effect on the Metamaterials and piping to prevent any damage to them.

The colloidal chamber (31) and low pressure outlet (39) are heated to maintain a vaporizing temperature between 316 degrees and 420 degrees Celsius. The heating allows for the full vaporization of the slurry and for the vapors to be transferred without condensation through the impinging jet or other vaporizing apparatus and for the flashing within the reactor flash zone. Heating may be provided by infrared, microwave, convection, induction coil, steam or hot oil jacket, turbine engine exhaust, heat exchanger, endothermic and or exothermic generating sources.

The Distillation Reactor Apparatus comprises three main processing chambers: 1) the vacuum distillation chamber, 2) the atmospheric distillation chamber and 3) the central reactor flash zone and 4) the inter-apparatus filtration system with Chalcogel filtration, ceramic membrane, activated charcoal or other individual or combinations of fillers within a foam metal substrate which alternatively may be of a rare earth magnet construction.

The reactor may be constructed with advanced materials to prevent vortex or cavitation erosion and thermal effects such as cracking or brittling of metals such as those used and being developed within the global Aerospace and Defense industries as of the date of this filing. System piping, processing chambers, pump housings and columns may be extruded or hydro-formed to eliminate seams and minimize joint connections and will have Aerogel insulation to minimize heat loss or outside climates to effect processing temperatures.

The distillation apparatus may be constructed as a single system being vertically or horizontally combined with a mutually shared pre-treatment, flash zone and filtration system as described herein, or as separate stand-alone systems, or as an interconnected stand-alone system depending on the desired size and production capability of the refinery. In a separated stand-alone version the filtration system on the vacuum distillation reactor will be top mounted as a final filter for light oil relay to the atmospheric reactor. Whereas the atmospheric distillation reactor has the filtration system mounted upstream at the bottom entry to the first processing reactor chamber.

The vacuum distillation reactor's initial processing chamber consists of a single inward flowing or progressive series of subsonic cyclone apparatuses to which the last in the series may be a nitrogen injected Cryovortactor cyclone. Each progressive series may consist of a single or multiple cyclones each of which have a downward spiraling outer vortex and an inner upward flowing vortex. Heavier vapors are thrust downwards aiding in the separation processing and the cyclonic cones may be constructed with thermal heat jackets which would serve to collect particles and vaporize them dropping any residues to the bottom for recycle. The light oil vapors would rise and be pulled into the center vortex within the cyclonic cones and propelled upwards into the final Chalcogel filtration system. The chamber is pressurized with propane, an inert gas and or a mixed butane/propane gas processing atmosphere.

The vacuum distillation reactor has one or more vacuum actuated product exit ports located at specific height levels which correspond to the factions or straight-run cuts determined by specific type of boiling point ranges. The extracted oil vapors are classified in order of increased volatility and include in ascending order residuum (14), water (17), heavy vacuum oil (15), middle distillates (not pictured, see below) and light vacuum gas oil (16). At the bottom of the sediment pit is an extraction trap door (13) for the removal of sand and other particles deposited from the processing of tar sands, bitumen, waste oils and shale oil.

An additional processing chamber(s) may be added or the existing chamber(s) may be modified to provide ultra-deep Hydrotreating of the middle distillates by locating it just above the vacuum distillation Chalcogel filter system for an upflow feed. The chamber would enable consolidation of the Hydrotreating processes currently conducted as separate stand-alone processes. Such consolidated Hydrotreating tasks may include; Hydrodesulfurization, Hydronitrogenation, Hydroisomerization, Hydrocracking, Hydrofinishing, Hydroconversion, Hydrodearomatization and Hydrodeoxygenation. The Hydrotreating chamber could consist of a single or multiple hydroprocessing chambers depending on the product(s) specific requirements for being processed such as temperatures, pressures, catalysts, catalyst beds and others.

The vaporized feed stream's outer vortex exits at the downward directed narrowed tip where it then then expanding centrifugally propelling the heavy vapors downward further breaking the bonds of oil from impurities. The light oil vapors upon rebounding from the bottom of the reactor continue to rise until they are vacuumed into the central upward spiraling vortexes within the progressive series of processing cyclones. Upon rising to the top of the cyclone cone they enter in to the Chalcogel filtration system (18) and then continue upwards into the first processing chamber of the atmospheric distillation reactor. Any processing gases accompanying the light oil vapors are extracted for recycle through the central filter exit port (19) with any remaining processing or inert gas dissipated within the hydrogen atmosphere of the first processing chamber. The Chalcogel filter system can be removed and reinstalled through a side reactor access door. The filter's trace metals can be harvested for recycle from the magnetized foam metal grid with any contaminants being plasma atomized in an ancillary process.

The atmospheric distillation reactor (43) consists of one to six pressurized processing chambers, but preferably five chambers (21, 28, 30, 32 and 34). Each chamber vertically adjoins with the next chamber being separated by an upward flowing high-velocity air foil bladeless fan (25 & 41) each being energized by intensifier pumps (27) and pressurized with hydrogen processing gas which also prevents fouling. Gas feeds are tangentially connected to each of the upward flow directed air foil fans (41). The fans create a steady upward flow on the inner diameter walls of the reactor leaving the center section with a less volatile center processing section to allow the vapors to separate and rise to the proper extraction levels.

Each of the atmospheric distillation reactor's processing chambers contain flow baffles mounted at each processing chamber's ceiling height (22) which slow rising flows for processing, cascading “cupped ear shaped” Nautilus extraction rings mounted just below the baffles (45) which guide extraction flows into the exit ports (24, 29, 31, 33, 35 and 38). Optionally each processing section may contain a Chalcogel inter-chamber filtration system (25) which filters impurities consistent with next processing chamber's specific processed gas requirement before entering that next processing chamber and the processing and inert gas extraction port (39) which connects to a looped system of purification, recharge and recycle.

Each of the processing chambers is temperature regulated to a degree level conducive with the exact boiling point of each of the oil cuts to be extracted. The thermal extraction system is based upon ascending flows with descending temperature plateaus which aid in attaining the proper extraction level and in the proper purified state. The thermal temperature can range from ambient to a 1,000 degree Celsius or a targeted individual fuel's cracking level but preferable from a 400 degree Celsius range at the lowest chamber level with a graduated temperature descent down to 10 to 20 degrees Celsius at the very top of the reactor chamber.

Located just below the each air foil fan are a parallel series of vapor flow baffle plates (22) with an inward protruding “Nautilus ear” (40) shaped ring spanning the inner reactor wall radius (23). The ear shape protrudes in a manner as to cup and collect the upward ascending vapor when it reaches it maximum height and lingers which ensures the vapor is ready for extraction. Vapors which are still ascending beyond that level easily pass through the baffles rising upward into the next processing chamber.

The very top reactor processing chamber has an upper Chalcogel filtration system (36) to trap any remaining contaminants, separate and extract the processing gas(es) from the LPG thus allowing the purified LPG to flow through the top reactor exit port (38) for the next step in processing.

Another application of the Chalcogel filtration system is to integrate; a catalyst bed either as a separate layer(s) or as a mixed substrate filled filter with catalyst filled pockets and or pellets to function simultaneously as the processing flows pass through and or a quench and or flow mixing layer. The filter can be recycled into fuel and or cleaned and refilled. Another application is creating a tubular or multitubular for intra-pore diffusion and convection expanding the abilities for catalyst pocket, pellet or catalyst bed heat and mass transfer phenomena to occur. The multilayered Chalcogel system may also add a quench layer for added precision processing control. When utilized in-between individual processing chambers the catalyst integration can optimize quenching and mixing between filtrated or stand-alone catalyst beds for maximum temperature control and the option of either elimination or depending on the application maintaining separate interchamber temperature variances. The combined Chalcogel filtration and or mixed filtration-catalyst bed can be applied to any or all processing chambers within the Distillation reactor or the pretreatment system.

The Distillation Process begins with the oil slurry entering a heat pipe (44) which dually serves as a feed pre-heat and ancillary vaporizing apparatus prior to entering the impinging jet system. The impinging jet system pressurizes the pre-treated oil slurry and directs the flow to a injector pipe which is centrally mounted on the outer reactor wall and has a 20 degree to 65 degree injection trajectory, but preferably a 45 degree trajectory feed line into the reactor's flash chamber. The impinging jet propels the slurry at a high velocity to sustain a continuous flash vaporization process and maintain constant internal reactor pressurization.

The flash zone (3) is central reactor located and is surrounded by a Chalcogel filtration system (18) to filter the rising light oil gases before entering the atmospheric distillation chamber. As the vapors enter the flash zone they are centrifugally swept counterclockwise along the outer circumference of the flash zone walls where the flow is Swirler guided in a sharply downward spiraling direction into a tapering cyclonic cone (7) which also generates a counter swirling upwards flow inner vortex flow. The outward centrifugal force against the heated inner cone wall compresses and separates oil vapors from contaminants while incinerating heavy oil particles, volatile organics and other contaminants in an advanced wiped film evaporator manner. The high subsonic velocity of the flow is sustained by two to four or more intensifier pumps (5) which are parallel mounted to the flash zone's outer reactor wall. Each pump injects a continuous stream of processing and or inert gas(es).

Processing gases aid in the fractionation of heavy oils, additives and water and may include propane, butane, hydrogen and steam. Propane's ability to extract only paraffinic hydrocarbons and reject carbon residues allows for the rapid Deasphalting of heavy oils in the fast moving cyclonic flow of the apparatus. Butane when mixed with the propane in a mix range of 10% to 50% depending on the feed stream's asphalt and tar content to further promote metals separation at the molecular level.

The vacuum distillation processing gas could also include a single or multi-component mixture of n-propane, isopropane, n-butane, isobutane, ethane and some of the various butylenes, butane/propane mixtures (C3/C4 or B-P mix). The co-solvent can be propane, ethane, butane, propylene, 2-methylpropane, dimethylpropane, propadiene, diemethylether, chlorodifluromethane, diflouroromethane and methylfluoride. In addition to propane, organic solvents such as propanol and supercritical ethane can also be used.

The cyclonic vacuum distillation separation apparatus comprises an outer shell with inner upper central reactor located large cyclonic processing cone (7) upstream to a secondary, parallel series of smaller processing cyclonic cones (8) surrounding and downstream of the larger central cone. A third cyclonic separating cone is located downstream of the second series and optionally includes at least one third sized single cyclonic cone (not pictured).

The cyclonic cone system may include a heat jacketed cone which serves as an advanced art invention to the wiped film evaporator, thin film and short path systems due to its high processing speed of 100,000 G's of gravitational force or higher, no moving parts and thorough filtration efficiency.

The separation efficiency of each of the three successive cyclonic processing steps is controlled by; the size of that particular series diameter of the inlet and outlet, the cyclone's diameter, body length, taper angle and the depth of the cylindrical inlet at the top of the cyclone. The feed stream is progressively purified within each series of cyclones with each series cyclone diameter progressively enlarging.

The downstream cyclonic processing flow begins with the smallest uniform sized cyclone or cyclones located within the outer radius of the reactor thus collectively comprising the first stage of the three stage series. The secondary processing cyclone or preferably eight cyclones (10) are uniform in size being slightly larger than the first series and also running parallel with each other, but positioned lower to the first stage series of cyclones, thus forming the secondary inner radius chamber.

The third and final processing stage is conducted in a large central cyclone (7) positioned lower than the first (8) or second series to which the central upward flowing vortex is Chalcogel filtered before entering the atmospheric distillation chamber (43) or alternately exited for further processing.

The outer annular chamber flow continues in a counterclockwise and downward spiral until it passes through the heat jacketed central inner wall's perforated passageways (10) and on into the secondary annular chamber. The inner wall with through-hole passageways is maintained at a constant 420 degree Celsius temperature on its outer surface to serve as a first stage wiped film or short path evaporator to destroy volatile or semi-volatile organics and vaporize any particles of dust and dirt from the vaporized streams.

The through-holes are rectangular shaped and contain cross-sections with width-to-height ratios in the range of 1.5:1 to 1:1.5 to prevent any larger particles from entering the inner secondary chamber. The rectangular cross section of the through-holes maximizes the limited available shroud space and produces a low pressure drop across the shroud.

As the flow enters the secondary chamber the outer vortex flows in a counterclockwise, down spiraling direction around the circumference of the inner chamber wall thus creating a secondary upward flowing vortex funnel. The upward flow then enters the small openings of the cyclonic cones to create both an outer centrifugal vortex of heavier vapor which is directed down into the primary central cyclonic cone and an inner smaller vortex funnel of light vapor oil which exits the top chamber plate through a single vortex finder opening.

The central cyclonic cone's (9) inner surface is heated to an outer preferred surface temperature of 425 degrees Celsius, although the temperature range may vary form 100 degrees to 500 degree Celsius or above, by an internal heat jacket filled with steam, hot oil, hot fuel, a molten liquid, infrared or induction coils, microwave, convection or other heat source. By adding a rough surface to the inner cyclonic cone surface it aids in the final capture and thermal destruction of any remaining contaminants. The high counterclockwise centrifugal force impact against the inner cone wall also aids in the final fractionation or impurities from the vaporized base oil.

When constructing the cyclonic cone system one must calculate each series of cones top diameter, bottom cone opening diameter, taper angle of the cone and surface condition to match the standard feed stream the system is being designed for.

Upon exiting the primary central cyclonic cone and third stage of the cyclonic process the feed stream vortex flows into a cylindrical atmospheric processing chamber which is permeated with a processing gas such as propane, butane or a mix of both.

Just above the bottom of the reactor are a series of electrode grid baffle plates (12) which provide electrostatic desalting and condensation of the descending heavy asphalt and residuum laden vapors to ensure that any remaining moisture is removed from the vapor stream prior to oil vapor extraction.

At the bottom of the vacuum distillation chamber just below the electrode grid baffles is a combined residuum, desalted water and particle collection pool (13) with a bottom pool cleanout door. As the desalted water and residuum drop into the pool the water floats on top of the residuum to allow for easy extraction and any sediment sinks to the very bottom. The water is extracted and forwarded to the water purification plant and the residuum is vacuum extracted and forwarded either to the fuel slurry plant for use as a coal slurry blanket, to the asphalt plant for asphalt production or to the deasphalting plant for further processing.

The Atmospheric Distillation feed stream first passes through a Chalcogel filtration system (18) which is constructed with a foam metal, rare earth magnetic and or electromagnetic conducting substrate to remove trace metals from the stream and for filter support and to withstand the high velocity flows. The filter system is able to capture by absorption or adsorption, separate, and contain contaminants for recycle including trace metals, minerals, volatile organics, contaminating compounds and gases such as nitrogen and oxygen. The filtration system is located in central reactor and serves as a divider between the vacuum and the atmospheric distillation reactor chambers. The filters may be electromagnetic or rare earth magnetized or ionized to assist in the capture and containment of vaporized metals and other stream poisoning materials and gas compounds.

A set of two to four or more intensifier pumps are parallel mounted and connected to each air foil fan to supply processing gas(es) and optionally processing catalysts into each of the processing chambers. The bladeless fans are relayed to one another with inner flows mushrooming processing vapors against the baffle plates and redirecting the vapor flows back into the processing cell for flow timed processing and final cut extraction.

The atmospheric distillation reactor is sub-divided into 2 and up to 6 or more successive, cylindrical walled processing chambers, but preferably into 5 chambers (21, 28, 30, 32 and 34). Upward spiraling internal chamber flows are controlled by a series of high pressure bladeless gas foil fans (25) which are gas fed through intensifier pumps (5) mounted to the outer reactor walls (11) parallel to the bottom of the chamber to be injected. The horizontally mounted fan system is able to amplify the inflowing gas stream around the entire inner circumference of the chamber walls leaving the center area in a low pressure manner similar to the center of a hurricane eye which allows the oil vapors to purify and be extracted in a continuous and rapid manner.

Internal upward flow speeds are able to reach from 15 to 18 times with a Reynolds's number of 1615 and up to subsonic speeds with the intensifier pumps at peak speed. The fans operate under a laminar type gas flow with a Coanda effect method of entrainment.

At the top of each processing chamber mounted just below the next chamber's fan are multiple rows of alternating baffle plates (22) designed to slow upward flows so as to reach their exact boiling point with the targeted impurities removed and be extracted. The baffle plates may be heat generating to ensure each chamber maintains strict temperature controls. A Nautilus reactor packing system (40 top view & 45 side view) consists of a cup shaped ring mounted to the inner reactor wall and extending inwards so as to collect and transport the oil vapor cut to the extraction ports. Lighter oil vapors rise through the Nautilus ring center opening then through the next chamber's bladeless fan center into the next processing chamber. Each section repeats this process until only the LPG is left at the top of the reactor for extraction.

Temperatures in the atmospheric distillation reactor are controlled by a heat jacketed reactor wall system solely dedicated to each specific processing chamber's temperature requirements. The upper chamber baffle plates may also be heated for temperature control. Processing chamber temperatures range from ambient to cracking temperature of around 950 degree Celsius but preferably from 300 degrees and escalating downwards in each processing chamber to a final 40 degrees Celsius for the LPG processing. As the oil fractions are reacted with hydrogen a catalyst can be injected to produce high-value clean products. The operating conditions depend on the final application. For instance, temperatures could range between 350 and 390° C., and pressures between 60 and 90 bar for the production of ultra-low-sulfur diesel (<10 ppm).

Each extraction port is Nautilus “ear shaped” so as to cup and funnel the extracting vapors from the Nautilus ring into the outlet (24, 29, 31, 33, 35 & 38). The invention atmospheric distillation reactor combines various aspects of the initial process of Hydrotreating, hydro finishing and hydro desulfurization in an upstream location to expedite conversion into the finished refinery products.

A Chalcogel Filtration System has been designed to provide both an initial and a transitional filtration system for a multitude of varied and mixed oil streams being processed in a combined vacuum and atmospheric distillation reactor system.

Specific processing substances which poison the processing of the multitude of types of crude and heavy oils include sulfur, mercury, cadmium, nickel, zinc, lead, cadmium, thorium, water, particles, metals and gases such as oxygen and nitrogen compounds along with an endless list of engine generated contaminants found in recycled oils.

The filter system consists of cross layered Chalcogel with a foam metal substrate to withstand high velocity flows, impacts, pressure and extreme heat and cold process flows along the ability for magnetization to capture trace metals. The substrate is packed with various filtering and absorbent materials such as ceramic membranes, aerogel or Chalcogel in which a single cubic centimeter holds 10,000 square feet of surface area. Types of applicable related materials include Aerogels, sol-gels, colloid, SEAgel, Xerogel, Nanogel and Chalcogel hydrogel solution individually or as a mixture with an advanced composite, carbon, graphite, silica, powdered metals, foam metals, magnetic rare earths and others. It also may be utilized as a catalyst, plasma spray, deposition, coating, impregnation or filler within a preformed substrate and or template filter system. The aerogel, Chalcogel, Sol-gel, colloid, Xerogel and Nanogels may be manufactured, processed and or supercritically or template produced with porous “pockets” in between the substrate which match the contaminant molecular size for a complete capture and collection of that contaminate to purify the stream being processed. By layering such pockets a flow may be 100 percent purified.

Other optional filtering materials include; glass fiber based filtering materials, absorbing carbon or graphite based composites, ion exchange resins, molten salt bath, liquid hydrogen vapor bath, Hydrophilic membrane fabric, fuel cell filtration and others.

The filter system can accommodate liquid, gas, supercritical, mist and vapor state flows. The outer layer is constructed with a larger foam metal pocket to hold more filtration element as the initial pass will be the most contaminated. A second and third layer will have progressively smaller pockets which being more compact will provide a thorough filter of any feed stream. The filtering system consists of two or more internal reactor filters each spanning the full diameter of the reactor to ensure total filtration of process vapor streams. A central filter separates the vacuum distillation reactor from the atmospheric distillation reactor chamber or if the two reactors are constructed separately it would be located on the top of the vacuum distillation reactor and on the bottom or feed side of the atmospheric distillation reactor. A third Chalcogel filter is located at the very top of the atmospheric distillation reactor as a final LPG filter prior to exiting for further processing.

A central filter located gas ejection pipe network allows for the vacuum distillation processing gas(es) to be removed prior to the stream entering the atmospheric reactor's first processing chamber (18). The perforated pipe allows for the heavier processing gas to concentrate within the pipe system for vacuum extraction and recycle while allowing the light oil vapors to pass by and continue ascending upwards. DISTILLATION REACTOR

### Vacuum Distillation Chambered Reactor

1. Mixed oil feed line (Pre-treated, purified & saturated)
2. High velocity feed pump (impinging jet, Intensifier pump & or others)
3. Flash vaporization and vortex intensifier zone
4. Vortex directional guide posts
5. Intensifier pumps—2 to 4 or more
6. Process &/or inert gas feed lines
7. Central chamber high velocity vortex processing zone
   a. Single large vortex cone
   b Inner cone 429° Celsius heated surface
   c. Counterclockwise flow,
   d. Computer regulated speeds from zero to subsonic processing flows
8. Secondary vortex processing zone
   a. Elevated above and parallel fixated around the central vortex
   b. 2 to 32 total small vortex cones,
   c. Optionally heated or non-heated cones
9. Third vortex processing flow zone (optional and Not Pictured)
   a. Elevated and parallel fixated above the secondary vortex level
   b. Optional 2 to 32 small cones
10. Circular vortex chamber with heated flow-through wall
11. Optionally heated inner chamber walls (In both vacuum & Atmospheric Distillation Chambers)
12. Desalt electric grid system (constructed with rare earth magnetic or electro-magnetic metal)
13. Residuum I water collection and extraction pool
14. Residuum vacuum extraction port
15. Heavy vacuum oil extraction port
16. Light vacuum gas oil extraction port
17. Water extraction port
18. Central and or inter-chamber filtration, quench, mix and or integrated and or separate catalyst bed, tube or mass transfer system with or without rare earth magnet, substrate, barrier or template
19. Chalcogel filter reactor access door
20. Processing I Inert gas extraction port

### Atmospheric Distillation Chamber (#43)

21. High temperature fuel processing chamber
22. Vapor baffle plates
23. Nautilus extraction ring—(5) total
24. Gas oil vacuum extraction port
25 Air-foil high velocity processing fan
26. Air-foil gas injection feed port
27. Intensifier pump process and or Inert gas Injector
28. Mid-range temperature fuel processing chamber
29. Diesel oil vacuum extraction port·

### (Atmospheric Distillation Reactor Continuation)

30. Low temperature fuel processing chamber
31. Jet fuel I kerosene vacuum extraction port
32. Naphtha processlne chamber
33. Heavy naphtha vacuum extraction port
34. LPG processing chamber
35. Light naphtha vacuum extraction port
36. Upper reactor Chalcogel filter
37. Chalcogel filter access door
38. LPG vacuum extraction port
39. Process I inert gas extraction port
40. Nautilus packing ring showing the extraction port opening (Top view looking upward)
41. Cross section view of the air-foil fan
42. Vacuum Distillation chamber
43. Atmospheric Distillation chamber
44. Pipe furnace feed vaporizer I (alternatively) catalytic preheat feed trajectory pipe
45. Nautilus reactor packing side view
46. High intensity ultrasound—(optional in reactor walls, process cones & inner chamber walls)
47. Sediment trap door cleanout (particles, sand, dirt)
48. Middle distillate (optionaJ Hydrotreating chamber not pictured)
   llydrodcsuJ furization
   Tlydronitrogcnation;
   llydrodeoxygenation;
49. Paraffinic Froth Treatment (not pictured) (Aqueous slurry product)

### Mixed Feed Pre-treatment Reactor System

1. Crude oil feed line (heavy, light, tar sand, shale oil, bitumen)
2. Spent oil feed line
3. Pyrolyic oil feed line (coal slurry, carbon material)
4. Flow regulators (computer controlled)
5. Pre-treatment mixing tank (series in succession option) (Catalysts, hydroxides, surfactants, solutions, additives, chelating agents, steam & reagents)
6. High pressure intensifier pumps (pulsed or continuous)
7. Impinging jet (option)
8. Treatment storage tanks with injection disbursement
9. High shear zone
10. Colloidal impact chamber
11. Colloidal high-velocity regulators
12. Transfer pipe
13. Low pressure pre-heat chamber
14. Processing gas injection line
15. Hydrodynamic Metamaterial targeted electro cavitation tube
16. Archimedes processing & mixing chamber
17. High-intensity ultrasound injectors
18. Flow Swirler (elbow/T-connector)
19. Furnace tube pre-heater & vaporizer (option to the impinging jet)
20. Injection pumps with flow regulator
21. Heat elements (infrared, convection, heat jacket, microwave, etc.)
22. Heat exchanger
23. Hydrate & natural gas feed line
24. Primary pre-mixed & treated feed streams
25. Secondary treatment & purification reactor

1. A combined vacuum distillation reactor with an atmospheric distillation reactor apparatus.

2. A vacuum distillation chamber with a single or a series of three or more interconnected cyclonic separating cyclones.

3. An atmospheric distillation chamber with a series of 1 to 5 or more thermal processing chambers.

4. A bladeless gas foil relay fan apparatus

5. High pressure intensifier pump actuated processing gas feed system.

6. A heated wiped film, short path, thin film evaporator and processing vortex cyclone.

7. Rare earth magnet foam metal filtration apparatus for trace metal filtration.

8. A merged carbon feed stream pre-treatment and distillation method

9. Colloidal impact pre-mixing method.

10. Turbine engine exhaust flow kinetic energy and thermal energy processing and power generation system.

11. Impinging jet feed apparatus

12. Chalcogel filtration system

13. Metamaterial central target plate apparatus with ultrasound cavitation method.

14. Cyclonic flash zone carbon feed stream separation apparatus for heavy and light oil, waste oil, bitumen, peat and other oil processing

15. A pipe furnace pre-heat system and oil feedstock vaporizer
